(19) United States
(12) Patent Application Publication
(10) Pub. No.: US 2025/0146814 A1
(43) Pub. Date: May 8, 2025

(54) MEASURING UNIT, AND MEASURING METHOD OF MEASURING STRAIGHTENED WIRE-SHAPED OR TUBULAR MATERIAL

(71) Applicant: WAFIOS Aktiengesellschaft, Reutlingen (DE)

(72) Inventors: Andreas Gönninger, Grafenberg (DE); Jürgen Wolf, Walddorfhäslach (DE)

(73) Assignee: WAFIOS Aktiengesellschaft, Reutlingen (DE)

(21) Appl. No.: 18/705,442

(22) PCT Filed: Oct. 24, 2022
(86) PCT No.: PCT/EP2022/079558

§ 371 Date: Apr. 26, 2024

(30) Foreign Application Priority Data
Oct. 26, 2021 (DE) 10 2021 212 056.3
Apr. 25, 2022 (DE) 10 2022 203 993.9

(51) Int. Cl. G01B 21/20; B21D 7/14

(52) U.S. Cl. CPC G01B 21/20; B21D 7/14

(57) ABSTRACT

A measuring unit that measures residual curvatures on straightened straightening good in the form of wires or tubes, which straightening good has passed through a straightening system having two series-connected settable roller straighteners with differently oriented straightening planes, includes a measuring device that receives a respective rod-shaped section, which has been severed from the straightening good, of the straightening good that has passed through the straightening system in a measuring position and determines measurement data that represent a residual curvature of the straightened straightening good; wherein the measuring unit is configured for a straightening plane-specific measurement that allows an unambiguous assignment of the curvature components represented by the measurement data to the different straightening planes of the roller straighteners.

### CROSS-REFERENCE TO RELATED APPLICATIONS

This application is a US national stage filing under 35 U.S.C. § 371 of International Application No. PCT/EP2022/079558, filed Oct. 24, 2022, which claims priority to German Patent Application No. 10 2021 212 056.3, filed Oct. 26, 2021, and German Patent Application No. 10 2022 203 993.9, filed Apr. 25, 2022, each of which is incorporated herein by reference in its entirety.

### TECHNICAL FIELD

This disclosure relates to a measuring unit and a measuring method of measuring residual curvatures on straightened straightening good in the form of wires or tubes, which straightening good has passed through a straightening system having two series-connected roller straighteners with differently oriented straightening planes.

### BACKGROUND

Wires, tubes or other elongate semi-finished materials are often present in the form of wound material supplies (coils) immediately after they have been produced, and normally have to be straightened before they are processed further. Straightening is a production process from the group of forming processes and is used to put the elongate material, which is also referred to here as straightening good, into a form that is as straight as possible before it is processed further, that is to say into a state with little or minor residual curvature. In a straightening process, the material is thus conveyed from a material supply through a straightening system, and the straightening system produces straightened material or straightened straightening good from the material by forming in a straightening operation.

Straightening systems of the kind considered in this disclosure have at least two roller straighteners. A roller straightener comprises a multiplicity of passive straightening rollers, that is to say straightening rollers not driven in rotation, having mutually parallel axes of rotation that are arranged alternately on opposing sides of a throughfeed path in one throughfeed direction and define a straightening geometry during operation with circumferential sections in contact with the workpiece. Using a roller straightener, it is possible to modify one-dimensional input curvatures (curvatures before entering the roller straightener) of a straightening good in a plane such that a defined residual curvature is present in the plane after the straightening process. In most situations, the aim is to achieve an end product without residual curvature, that is to say a straight end product. In most situations, use is made of straightening systems having two series-connected roller straighteners, which eliminate the input curvatures in two mutually perpendicular planes.

Straightening systems having roller straighteners do not rotate and, in this respect, basically differ from rotating straightening systems having what are known as straightening blades, which apply straightening forces in multiple different planes.

In settable roller straighteners, at least one of the straightening rollers is adjustable in an adjustment direction oriented transverse to the throughfeed direction. The straightening geometry of the roller straightener may thereby be modified to achieve a better straightening result. Depending on the type of roller straightener, a straightening roller may be adjusted manually, partially automatically or by way of an assigned actuator (for example, servo motor, pneumatic cylinder, hydraulic cylinder and the like) in response to control signals from a control unit.

Insufficient straightening results may occur, for example, when beginning to use fresh straightening good following a coil change or following a changeover to another process. Material inhomogeneities, changes in material characteristics and/or wear to straightening rollers may also lead to deterioration of the straightening results during the ongoing process. Raw material is also subject to production tolerances. Changes may be recognized by carrying out regular checks based on random samples. If there is an unacceptable deterioration in straightening quality, the straightening system should be set up better by changing the straightening geometry.

In practice, a machine operator requires a great deal of experience and skill to ensure a sufficiently consistent straightening quality for the machine being maintained. There are already numerous approaches for achieving production processes with reproducibly good straightening quality independently of the capabilities of a machine operator.

DE 195 03 850 C1 describes a non-rotating straightener for bending machines having an integrated measuring device. The straightener comprises at least one non-rotating straightening mechanism for wire or strip material that operates in at least one straightening plane. The straightening mechanism has multiple successive straightening rollers that process the material, these being settable, by way of at least one actuator, in the straightening plane and transverse to the throughfeed axis of the material. In the throughfeed direction of the material downstream of the straightening mechanism, provision is made for a material bending measuring device, in which provision is made for at least one measuring path for a material section of predetermined length, and at least one mechanical and/or electronic and/or optical scanning device that determines the extent of the bending and the direction of bending is arranged along the measuring path, wherein signals representing the measured bending of the material section are able to be generated by the scanning device, and wherein the actuator of at least one straightening roller is an actuator that responds to the signals with corrective actuating movements.

It could therefore be helpful to provide a measuring unit and a measuring method of measuring straightened straightening good in the form of wires or tubes, which measuring unit and measuring method enable precise measurements of the residual curvature on straightened straightening good and deliver meaningful measurement results that are able to be used when setting up and during operation of the straightening system to control the straightening geometry of the roller straighteners quickly and systematically such that good straightening results are able to be achieved.

### SUMMARY

In this Summary reference numerals are provided referring to the drawing figures. These are to aid in understanding the disclosure, and are not meant to limit this disclosure to the specific embodiments shown or described.

Some embodiments provide a measuring unit (350) that measures residual curvatures on straightened straightening good in the form of wires or tubes, which straightening good has passed through a straightening system having two series-connected settable roller straighteners with differently oriented straightening planes, comprising: a measuring device (520) that receives a respective rod-shaped section (110 A), which has been severed from the straightening good, of the straightening good that has passed through the straightening system in a measuring position and that determines measurement data that represent a residual curvature of the straightened straightening good; wherein the measuring unit (350) is configured for a straightening plane-specific measurement that allows an unambiguous assignment of the curvature components represented by the measurement data to the different straightening planes of the roller straighteners.

Some embodiments further comprise: fixing apparatuses (510, 610) that fix the rod-shaped section at a first fixation point and at a second fixation point located at a distance from the first fixation point such that, for each of the fixation points, only a vertical position and a horizontal position of the rod-shaped straightening good is predefined such that a section of the rod-shaped straightening good that is located between the fixation points is free from forces aside from gravity; measuring apparatuses (520, 620) that measure a position of the straightening good in a measuring plane (524) located between the first and the second fixation point; and apparatuses for determining that determine the residual curvature using position data for the position of the straightening good at the first fixation point, at the second fixation point and in the measuring plane (524).

In some embodiments, the measuring unit has a cutting apparatus (370) that severs rod-shaped sections (110-A) of predefinable length from the straightening good that has passed through the straightening system, wherein and the cutting apparatus (370) is mounted, together with the measuring device (500), at or on a common frame.

In some embodiments, the measuring unit (350) is configured such that the straightening good is able to be measured in that rotational position in which it passed through the straightening system (400).

Some embodiments further comprise anti-twist apparatuses (514-1, 514-2) that are configured such that a rotational position of a severed rod-shaped section (110-A) provided for the measurement remains unchanged about its longitudinal axis between the straightening and the measurement such that the straightening good is able to be measured in that rotational position in which it passed through the straightening system.

Some embodiments further comprise a control unit (390) that is configured in an operating mode such that the cutting apparatus (370) and the measuring device (500) are controlled in a coordinated manner such that a front end section (112) of the straightened straightening good is conveyed to a measuring position in the measuring device (500) by way of a controlled advancement, the straightening good is then secured against twisting by way of anti-twist apparatuses (514-1, 514-2) of the measuring unit (350), or is clamped in the horizontal direction, and the cutting apparatus (390) is then actuated to sever the rod-shaped section to be measured from the rest of the straightening good.

In some embodiments, the measuring unit (350) has a rotational position adjustment auxiliary apparatus (550) that is configured, in functional interaction with a rotational position marking (115) on the rod-shaped section (110-A) that is suitable for identifying the rotational position of the rod-shaped section, to ensure that the rod-shaped section is able to be received in the measuring unit such that the rod-shaped section is able to be measured in a defined rotational position that has a known relationship with the rotational position in which the straightening good passed through the straightening system (400), the rotational position adjustment auxiliary apparatus has at least one rotational position detection apparatus that is configured to detect the rotational position marking (115) on the rod-shaped section (110-A), and the rotational position detection apparatus is selected from the following group: a camera (558) for optically detecting the rotational position marking; a mechanical marking counter-element for making mechanical contact with the rotational position marking (115), wherein the marking counter-element preferably has a section having a counter-structure (556) complementary to the rotational position marking such that the desired rotational position of the rod-shaped section is able to be set by the contacting.

In some embodiments, the measuring device (500), on an input side, has a first clamping device (510-1) and a second clamping device (510-2) at a distance therefrom in the longitudinal direction, wherein components of a measuring system (520) are arranged in a region between the clamping devices (510-1, 510-2), which measuring system defines a measuring plane (524) oriented transverse or perpendicular to the longitudinal direction and is designed to ascertain the position of the set-down rod-shaped section (110-A) in the measuring plane (524), wherein preferably each of the clamping devices has a support roller (512-1, 512 2) mounted with a horizontal axis of rotation and two transverse positioning elements able to be adjusted by way of a drive or transverse positioning rollers (514-1, 514-2) or transverse positioning blocks such that an inserted rod-shaped section is able to be fixed at a fixation point defined in each case in the vertical direction and in the horizontal direction.

In some embodiments, a distance, measured parallel to the longitudinal direction, between the clamping devices (510-1, 510-2) is continuously adjustable, wherein preferably the clamping devices are mounted on carriages that run on guide rails (501) that are attached to the top of a horizontally oriented baseplate (502) of the measuring system, and/or components of the measuring device are attached to a carrier (522) that is mounted on a carriage that is able to be moved on the guide rails (501) that also guide the clamping devices.

In some embodiments, the measuring system (520) is an optical measuring system that ascertains the position of the rod-shaped section in a measuring plane (524) located between the clamping devices, wherein the measuring system has a first laser unit (525-1) and a second laser unit (525-2) that produce a respective laser light curtain running in the measuring plane in measuring directions oriented transverse or perpendicular to one another, wherein a sensor unit having photosensitive sensors that detect a shadow cast by that part of the rod-shaped section (110-A) entering through the measuring plane is arranged in each case opposite a laser unit.

Some embodiments provide a measuring method of measuring residual curvatures on straightened straightening good in the form of wires or tubes, which straightening good has passed through a straightening system having two series-connected roller straighteners with differently oriented straightening planes, wherein a rod-shaped section (110-A) of predefinable length is severed from the straightened straightening good that has passed through the straightening system (400) by way of a cutting apparatus (370), and the rod-shaped section is measured by way of a measuring apparatus (500) that comprises a measuring device (520) that receives a respective rod-shaped section (110-A) severed from the straightening good in a measuring position and apparatuses that determine measurement data that represent a residual curvature of the straightened straightening good, comprising a straightening plane-specific measurement, in which curvature components determined on the basis of the measurement data are assigned to the different straightening planes of the roller straighteners.

Some embodiments provide such a method, wherein a rotational position of the straightening good remains unchanged about its longitudinal axis between the straightening and the measurement such that the straightening good is measured in that rotational position in which it passed through the straightening system.

In some such methods, to measure a rod-shaped section of the straightening good, a front end section (112) of the straightened straightening good is first of all conveyed to a measuring position in the measuring device (500) by way of a controlled advancement, the straightening good is then prevented from self-rotation by way of anti-twist protection, in particular by being clamped in the horizontal direction, and in that the rod-shaped section (110 A) to be measured is then severed from the rest of the straightening good.

Some embodiments of such methods further comprise producing a rotational position marking (115) suitable for identifying the rotational position of the rod-shaped section (110-A) on the rod-shaped section; transporting the rod-shaped section provided with the rotational position marking to the measuring unit (350); arranging the rod-shaped section (110-A) provided with the rotational position marking (115) in the measuring position of the measuring unit with a defined rotational position, which has a known relationship with the rotational position in which the straightening good passed through the straightening system (400), wherein the defined rotational position is set using a rotational position adjustment auxiliary apparatus (550) of the measuring unit that is configured, in interaction with the rotational position marking (115) on the rod-shaped section, to ensure that the rod-shaped section is arranged in the defined rotational position.

In some embodiments, producing the rotational position marking (115) comprises one of: producing a notch or another recessed structure on the circumference of the straightening good; producing a bent section at the end of the straightening good; producing a chamfer at the end of the straightening good; producing a color marking or laser marking; removing one side of part of an insulating layer; applying a marking element that has been produced separately and has a matching shape to the rod-shaped section, in particular by plugging, clipping or gluing, and gluing a self-adhesive sticker to or on a side surface of the rod-shaped section.

In some embodiments, measuring the straightened straightening good comprises: fixing the straightened straightening good at a first fixation point and at a second fixation point located at a distance from the first fixation point such that, for each of the fixation points, a vertical position and a horizontal position of the straightening good is predefined and a section of the straightening good that is located between the fixation points is free from forces aside from gravity; measuring a position of the straightening good in a measuring plane (524) located between the first and the second fixation point; and determining the residual curvature using position data for the position of the straightening good at the first fixation point, at the second fixation point and in the measuring plane (524).

In some embodiments, an optical measuring system is used for the measurement, which optical measuring system preferably produces two mutually perpendicular laser light curtains located in the measuring plane by way of laser radiation and performs detection by way of opposing light-sensitive sensors, as a result of which the position of the straightening good in the measuring plane is able to be ascertained with high precision in two directions by way of shadow projection.

Some embodiments provide a method of setting up a straightening system (400) for straightening passing straightening good (110) in the form of wires or tubes, in particular for use in a forming machine for producing straight or bent shaped parts from the straightening good, wherein the straightening system (400) has two series-connected settable roller straighteners (400-1, 400-2) with differently oriented straightening planes, a rod-shaped section (110-A) of predefinable length is severed from the straightened straightening good that has passed through the straightening system (400) by way of a cutting apparatus (370), the rod-shaped section is measured by way of a measuring apparatus (500) that comprises a measuring device (520) that receives a respective rod-shaped section (110-A) severed from the straightening good in a measuring position and apparatuses that determine measurement data that represent a residual curvature of the straightened straightening good, and the straightening geometry of at least one roller straightener (400-1, 400-2) is modified on the basis of the measurement data such that a residual curvature of a subsequently straightened section of the straightening good is improved by changing the straightening geometry with regard to a target residual curvature, and a measuring apparatus as described herein is used.

### BRIEF DESCRIPTION OF THE DRAWINGS

FIG. 1 shows components of a feeding device for feeding wire material from a wire coil to a forming machine (not illustrated), wherein the feeding device is arranged on a setup station having an integrated straightness measuring system.

FIG. 2 shows a magnified view of the straightening system of the feeding device from FIG. 1.

FIG. 3A shows a magnified view of the measuring device of the setup station from FIG. 1, and FIG. 3B shows a detailed view of the measuring plane.

FIGS. 4A to 4C show a method variant in which self-rotation of a severed straightened round rod between separation from the rest of the wire and the measurement is prevented by way of anti-twist apparatuses.

FIGS. 5A to 5D show an alternative method variant in which a straightened rod made of flat material is severed and measured.

FIGS. 6A to 9 show various examples each having, on the feeding unit, apparatuses for producing a rotational position marking and, on the measuring unit, a rotational position adjustment auxiliary apparatus.

FIG. 10 shows a further example of a measuring device for measuring residual curvatures on severed straightened rods.

### DETAILED DESCRIPTION

Our measuring units and measuring methods are suitable for measuring residual curvatures on straightened straightening good in the form of wires or tubes, which straightening good has passed through a straightening system that has (at least) two series-connected roller straighteners with differently oriented straightening planes. Preferably, the straightening planes are oriented perpendicular to one another; in particular, one of the straightening planes is horizontal and the other is vertical.

The measurement is performed on rod-shaped sections (rods) of predefinable length (rod length) that have been severed from the straightening good that has passed through the straightening system by way of a cutting apparatus. A single rod is measured at a time.

The measuring unit comprises a measuring device for receiving a respective rod-shaped section in a measuring position and for determining measurement data that represent a residual curvature of the straightened straightening good.

One special feature is that the measuring unit is configured for a straightening plane-specific measurement that allows an at least approximately unambiguous assignment of the measurement data or of the curvature components represented by the measurement data to the different straightening planes of the roller straighteners.

A roller straightener straightens only in a single straightening plane. If two roller straighteners with different straightening planes, in particular with straightening planes oriented perpendicular to one another, that are run through in succession are provided in the straightening system, curvatures in the two straightening planes are able to be assessed independently of one another as a first approximation. We found that it is important, for targeted setting or adjustment of the straightening rollers during the setup process or as part of regulation during operation, to be able to unambiguously assign the measurement results determined on the straightening good to the individual straightening planes. Measuring methods and measuring devices that allow this are referred to as “straightening plane-specific” or “straightening plane-selective measurement”.

It is known practice to measure the straightness or residual curvature on a section of the straightened straightening good that is still attached to adjacent sections of the straightening good. It may, where applicable, be measured when the straightening good is passing through, that is to say in phases in which the straightening good is moving forward. It may also be possible to stop the straightening good for a short time for the measurement (cf. DE 195 03 850 C1). We consider it disadvantageous that it may be that the stresses and forces applied by other sections of the straightening good may influence the shape of the measured section to such an extent that the true curvature state is not measured.

The measurement is performed on rod-shaped sections or rods of predefinable length that have been severed from the straightening good after it has passed through the straightening system by way of a cutting apparatus. Due to the separation from the following remainder, the straightening good of the rod that is to be measured is able to relax without external force such that the shape of the rod represents the true curvature conditions in at least approximately undistorted form. We found that it is possible to achieve significantly better interpretable measurement results if a relatively short rod-shaped section is severed from the straightening good and this rod is then measured or subjected to a straightness test.

This makes it possible to achieve precise quantitative statements about curvature components using measuring methods that are relatively easy to perform and evaluate, which curvature components may be assigned unambiguously to the different straightening planes in the evaluation.

Preferred rod lengths are generally significantly smaller than one meter; depending on the stiffness of the straightened material, they may, for example, be 300 mm to 700 mm.

Further advantages of this configuration may be understood as follows. Many conventional straightness measuring systems are designed to allow a global statement about the curvature state of straightening good, for example, to distinguish between sufficiently well-straightened straightening good with the desired straightening quality and straightening good with insufficient straightening quality. In contrast thereto, our measuring units and measuring methods are not only able to determine global values for the residual curvature, but also the information, resulting from the measurement, about the curvature state of the rod-shaped section may be separated into curvature components that are able to be assigned unambiguously to the individual straightening planes of the straightening system. Such a straightening plane-specific or straightening plane-selective measurement makes it possible to quantitatively ascertain which component of a determined residual curvature was caused by which of the at least two straighteners.

Using this information, which is broken down by straightening planes, about the curvature state of the straightening good, the roller straighteners may then be set in a targeted manner, for example, as part of the setup of the straightening system, to achieve a suitable setting of the straightening rollers with few tests. If, for example, a straightening system has a first roller straightener having a vertically oriented first straightening plane and a second roller straightener downstream thereof having a horizontal straightening plane, then horizontal and vertical components of the residual curvature may be quantified separately from one another on the basis of the measurement data. Accordingly, in a setup process, for example, when an identified residual curvature is predominantly or exclusively in one of the straightening planes, the adjustment of straightening rollers may be concentrated on that straightener whose straightening plane is affected by the excessively great residual curvatures. As already mentioned above, it is possible to make an important contribution to achieving meaningful measurement results by carrying out measurements on severed rods of appropriate finite length. Due to the separation from the following remainder, the straightening good that is to be measured, that is to say the severed rod, is able to relax without external force such that the shape of the rod represents the true curvature conditions in at least approximately undistorted form. To enable such measurements on the relaxed rod, some examples have apparatuses for fixing the rod-shaped straightened straightening good at a first fixation point and at a second fixation point located at a distance from the first fixation point, which apparatuses are designed and arranged such that, for each of the fixation points, only the vertical position and the horizontal position of the rod-shaped straightening good is predefined such that a section of the rod-shaped straightening good that is located between the fixation points is free from forces aside from gravity. Furthermore, provision is made for apparatuses for measuring a position of the straightening good in a measuring plane located between the first and the second fixation point, and for apparatuses for determining the residual curvature using position data for the position of the straightening good at the first fixation point, at the second fixation point and in the measuring plane.

The type of largely force-free position fixation gives the received rod certain degrees of freedom in terms of spatial orientation at the fixation points, meaning that a rod is able to relax to form a curvature. This is considered to be an important difference in relation to solutions in which a wire to be measured is measured in a region between two wire guides that would each closely enclose the wire on all sides and prevent any inclined orientation.

The measuring unit may work with severed rods that have been severed by way of a cutting apparatus that belongs to another machine upstream in the process, for example, to a straightening and cutting machine whose final products are straightened rods. In these examples, no separate cutting unit is required on the measuring unit.

The measuring unit has a cutting apparatus for severing rod-shaped sections of predefinable length from the straightening good that has passed through the straightening system. The measuring device is connected downstream of the cutting apparatus in the material flow direction. Owing to the integrated cutting apparatus, the measuring unit, as an autonomous unit, is able to sever rod-shaped sections of suitable length from straightened continuous material and to carry out straightness measurements or measurements of the residual curvature on these sections.

The cutting apparatus may be mounted, together with the measuring device, at or on a common frame of the measuring unit to ensure a fixed positional relationship and to form a functional unit, which may be used, for example, as a setup station. One example of such an autonomous measuring unit is explained in more detail below.

To achieve a straightening plane-specific or straightening plane-selective measurement, provision is preferably made for the measuring unit to be configured such that the straightening good is measured in that rotational position in which it passed through the straightening system. The term “rotational position” refers to the rotational position or rotational orientation with respect to a self-rotation about the longitudinal axis of the straightening good. Although straightening plane-specific measurement data could also be determined by measuring any rotation of the straightening good between severing and measurement and then correcting the measurement data determined by the measuring device with regard to the direction of rotation, it is considered to be much easier and more accurate to rule out such self-rotations through process-engineering and design measures.

Since a severed rod of suitable length is severed from the rest of the straightening good for the measurement, self-rotation of the rod about its longitudinal axis between the act of severing and the act of measurement should be avoided to enable an unambiguous assignment of the measurement results to the corresponding roller straightener. This may be a problem in particular when processing round material, for example, if it is placed such that it rolls along an inclined surface between being severed and measured. When machining material with a profiled cross section, for example, with a rectangular cross section, simple measures may be sufficient to prevent self-rotation, for example, by placing the straightening good, with one of its flat surfaces, on a straight or flat resting surface.

The measuring unit is characterized by anti-twist apparatuses that are configured such that a rotational position of a severed rod-shaped section provided for the measurement remains unchanged about its longitudinal axis between the straightening and the measurement such that the straightening good is able to be measured in that rotational position in which it passed through the straightening system. It is thus ensured, by way of anti-twist apparatuses and/or anti-twist measures, that the rotational position of the material remains unchanged about its longitudinal axis between straightening and measurement.

The measuring unit has a control unit that is configured in an operating mode such that the cutting apparatus and the measuring device are actuated or operated in a coordinated manner such that a front end section of the straightened straightening good, which front end section has been conveyed to a measuring position in the measuring device by way of a controlled advancement, is secured against self-rotation by way of anti-twist apparatuses of the measuring system, for example, by being clamped, and the cutting apparatus is actuated only thereafter to sever the rod-shaped section to be measured, which is secured against twisting, from the rest of the straightening good. The severed straightening good is able to be reliably stopped by way of clamping the straightening good or any another fixing measure that secures against twisting prior to the severing.

The coordination between cutting and measurement is particularly easy to implement in measuring units having an integrated cutting apparatus. However, control-related coordination is also possible in external cutting apparatuses, that is to say those that are not part of the measuring unit but rather belong to another unit.

In some variants, the straightening good is first of all conveyed into the region of the measuring device, received there in a manner secured against twisting, and only thereafter severed from the rest of the straightening good. In one example of the measuring device, the anti-twist protection may be ensured by way of elements of a clamping device that are able to be moved in the transverse direction.

It is also possible to provide a rod transport apparatus that is configured to grip a section to be severed of the straightening good before performing the cutting operation, to transport it to the measuring device after severing from the rest of the straightening good and to insert it or put it down or release it there with an unchanged rotational position after the rod-shaped section has been received in the measuring device in a manner secured against twisting.

As already mentioned above, the measuring unit may be configured such that the straightening good is able to be measured in that rotational position in which it passed through the straightening system. However, this is not mandatory, and so it may be that the rotational position of the rod-shaped section, when the rotational position of the rod-shaped section is measured, differs from the time of severing from residual material. In general, it is sufficient for the rod-shaped section to be received in the measuring unit such that the rod-shaped section is able to be measured in a defined rotational position that has a known spatial relationship with the rotational position in which the straightening good passed through the straightening system. If this occurs, then a straightening plane-specific measurement may be performed since the measurement results are able to be assigned to the individual straightening planes.

Some examples of the measuring method use this option by producing a rotational position marking on the rod-shaped section that is suitable for identifying that rotational position of the rod-shaped section that was present during straightening. The rod-shaped section provided with the rotational position marking is then transported to the measuring unit and arranged in the measuring positions of the measuring unit with a defined rotational position. This rotational position has a known spatial relationship with the rotational position in which the straightening good passed through the straightening system, meaning that a conversion or coordinate transformation is possible. To be able to set this defined rotational position reliably on a systematic basis, a rotational position adjustment auxiliary apparatus is used on the measuring unit, this auxiliary apparatus being configured, in functional interaction with the rotational position marking of the rod-shaped section, to ensure that the rod-shaped section is arranged in the defined rotational position for the measurement. The measurement results thus obtained may then be assigned unambiguously to the straightening planes.

There are different options for producing the rotational position marking. In some examples, a bend or a bent section is produced at or near one end of a rod-shaped section, which bend or bent section protrudes obliquely, as far as radially, to the longitudinal axis of the rod-shaped section in a certain direction, thus making it possible to precisely identify and if necessary reproduce the rotational position. The length of the bent section compared to the rest of the rod-shaped section is generally very short, for example, at most 20% or at most 10% of the total length of the rod-shaped section. For the purposes of this disclosure, a rod or a “rod-shaped section” is present not only when it extends substantially in a straight line over its total length. On the contrary, a rod or a rod-shaped section is present when it extends substantially in a straight line over the majority of its total length, for example, over at least 80% or at least 90% of its total length.

To produce the rotational position marking, a notch or other partially recessed structure may be embossed into the material of the section, for example, using a punch, a center punch, a knurling tool, or a texture-embossing tool. A cutting tool may also be used to produce the marking by guiding a working stroke only to the extent that the cutting edge penetrates the material slightly and produces a notch. If the material is an insulated wire, the rotational position marking may be introduced by partially or completely removing the insulating layer at a small point on the circumference such that the rotational position is able to be detected on the basis of the stripped point. In principle, it is possible to use any marking that results in a marked section exhibiting no rotational symmetry with respect to the longitudinal axis of the rod-shaped section. By way of example, it is possible to design the cutting apparatus such that a characteristic shape change that serves as a rotational position marking is introduced at the end of the rod-shaped section by the cutting operation for severing the rod-shaped section, for example, by producing a chamfer on one side. If multiple sides are intended to receive a chamfer, the chamfers may differ such that a chamfer that is able to be reliably distinguished from other chamfers may be used as a rotational position marking.

It is also possible to introduce a rotational position marking using a laser beam or by applying a colored marking or by gluing a preferably self-adhesive sticker to or on a side surface of the rod-shaped section. In contrast to the abovementioned possibilities of changing the shape of the rod-shaped section at one end through the action of mechanical forces, marking using a laser (laser marking) or using paint or stickers is one option for marking this without mechanical stress on the rod-shaped section.

It is also possible to use a marking element that is able to be produced separately and that is preferably asymmetric with a matching shape as a rotational position marking, which may be affixed to the free end before the rod is severed from the rest of the straightening good, for example, by plugging, clipping, clamping, gluing or the like. By way of example, a clip produced by 3D printing or a small cap may be plugged or placed or clipped onto the free end before the rod is severed. The rotational position is easily recognizable due to the asymmetry.

On the measuring unit, provision may be made for a rotational position adjustment auxiliary apparatus that is adapted to the type of rotational position marking such that it is possible, in functional interaction with the rotational position marking, to ensure that the rod-shaped section is arranged in the desired defined rotational position for the measurement. In one example, a marking or other orientation aid may be provided on the measuring unit itself such that a human operator or a robot is able to optically detect the rotational position to which the rod-shaped section should be brought for the desired measurement to be possible. It is also possible for a rotational position detection apparatus to have a camera for optically detecting the rotational position marking. Then, using the camera signal, the rod-shaped section may be arranged in the measuring unit such that it assumes the desired defined rotational position. This correct position orientation may be performed by an operator or semi-automatically or automatically.

Another possibility is to provide a rotational position detection auxiliary apparatus that has a mechanical marking counter-element for making mechanical contact with the rotational position marking of the rod-shaped section. The marking counter-element may, for example, have a section with a counter-structure complementary to the rotational position marking such that the desired rotational position of the rod-shaped section is able to be set through the production of the contact itself. Provision may be made for a counter-element that corresponds to the rotational position marking of the rod-shaped section. By way of example, provision may be made for a latching element that latches into a notch serving as a rotational position marking or a graining on a point of the circumference of the rod-shaped section. It may also be that its kinked or bent section has to be inserted into a corresponding recess at the end of the rod-shaped section, or the marking that has been produced by the cutting operation (for example, a chamfer) has to be placed on a correspondingly inclined surface to achieve the defined rotational position.

Using the described measures, in-process measurement/regulation may possibly also be carried out by feeding straightened rods to the measuring device during the production process on a regular or irregular basis according to a predefined scheme or as warranted and measuring them there to assess the straightening quality and, if necessary, make compensating changes to the setting of the straightening system. The rods removed from the material flow for testing purposes may then, if possible, be returned to the subsequent production step, but this is not mandatory. This means that, from time to time, straightened rods may be taken out of the material flow for measuring purposes and, if necessary, returned to the material flow after the measurement is complete.

The straightened straightening good, for the purpose of the measurement, is fixed at a first fixation point and a second fixation point located at a distance from the first fixation point such that a vertical position and a horizontal position of the straightening good (for example, in the horizontal direction transverse to the longitudinal direction of the rod) are predefined for each of the fixation points, and a section of the straightening good located between the fixation points is free from forces aside from gravity. The position of the straightening good is then measured in a measuring plane located between the first and the second fixation point. By way of example, this may be located centrally between the fixation points. The residual curvature of the wire section located between the fixation points is then determined using position data for the position of the straightening good at the first fixation point, the second fixation point and the measuring plane.

In design terms, a first and a second clamping device may be provided in the measuring device, these offering a support for the straightening good at the corresponding fixation points and having clamping elements able to be moved in the transverse direction, which bring the contact toward the straightening good and are thereby able to define the transverse position. The clamping elements, when they come into contact with the straightening good, should exert at most a very low force.

The measuring device, on a side facing or to be turned toward the cutting apparatus (inlet side), has a first clamping device and a second clamping device at a distance therefrom in the longitudinal direction, wherein components of a measuring system are arranged in a region between the clamping devices, which measuring system defines a measuring plane oriented transverse, in particular perpendicular, to the longitudinal direction of the measuring device and is designed to ascertain the position of the set-down rod-shaped section in the measuring plane. The measuring plane is preferably located centrally between the clamping devices, where the greatest deflections, in terms of magnitude, of the fixed rod-shaped section are typically expected, which benefits measurement accuracy.

Each of the clamping devices has a support roller mounted with a horizontal axis of rotation and two transverse positioning elements able to be adjusted by way of a drive such that an inserted rod-shaped section is able to be fixed at a fixation point defined in the vertical direction and in the horizontal direction. The upper section of the outer surface of the support roller may define the vertical position, while the laterally positioned transverse positioning elements predefine the position in the horizontal direction. The transverse positioning elements may be designed, for example, as rotatably mounted transverse positioning rollers. However, a rotation capability is not required. Provision may also be made for other, fixedly mounted transverse positioning elements, for example, transverse positioning blocks that may, for example, have a convexly curved front surface to offer only a point-shaped or linear contact surface for the straightening good.

In such examples of the measuring device, the anti-twist protection may be ensured by way of the transverse positioning elements able to be moved in the transverse direction, for example, in the form of transverse positioning rollers or blocks, of the clamping device, which thus function as anti-twist apparatuses. If a rod-shaped section is gently clamped laterally, for example, by way of transverse positioning rollers having a vertical axis of rotation or by way of transverse positioning blocks having a cylindrical front surface, then only the degree of freedom of rotation of the rod about its longitudinal axis is essentially disabled, whereas the clamping in the horizontal direction between substantially point-shaped contact points between the support rollers and the outside of the rod-shaped section does not substantially hinder potential sagging of the rod or deflections in vertical directions. It is thus possible to measure the true curvature state on a rod-shaped section that is supported at two points spaced apart from one another and is otherwise essentially subject only to gravity. As an alternative to roller-shaped transverse positioning elements, provision may also be made for other transverse positioning elements, which are potentially not mounted to be able to move, for example, blocks having convexly curved contact surfaces. The contact surfaces in contact with the workpiece should preferably be designed such that only essentially point-shaped or small-area physical contact arises such that the straightened rod is clamped only in the horizontal direction between essentially point-shaped contact points, meaning that any deflection in the vertical direction is not substantially hindered.

The anti-twist means may thus be elements with a suitable geometry that enable point-shaped or linear contact between the clamping device and the rod-shaped section. These include, for example, the rollers mentioned, but also non-rotatable elements that have a tip or a radius at least in the contact region, that is to say, for example, a cylindrically or spherically curved contact surface.

A distance, measured parallel to the longitudinal direction, of the clamping device is continuously adjustable such that the measuring device is able to be adapted easily to rod-shaped sections of different lengths. In most examples, the rod-shaped sections provided for the measurement are significantly shorter than one meter: depending on the stiffness of the straightened material, their length may, for example, be 300 mm to 700 mm, and possibly (in relatively thin rod materials) even less.

Although one of the clamping devices may be mounted fixedly and only the other may be moveable, the clamping devices are preferably mounted on carriages that run on guide rails that are attached to the top of a horizontally oriented baseplate of the measuring system. Both clamping devices may thus be moved continuously in a common axis and then fixed at the desired positions.

To be able to position the measuring plane correctly for different rod lengths, provision is made for components of the measuring device to be attached to a carrier that is mounted on a carriage that is movable on the guide rails that also guide the clamping devices. This creates an extremely stable arrangement that is able to be adapted easily to different dimensions of the rod-shaped sections to be measured.

In principle, any measuring device that delivers quantitative statements about the residual curvature in the straightening planes of the roller straightener and allows an unambiguous assignment of the measured residual curvatures to the straightening planes may be used to measure the straightening good after it has passed through the straightening system, that is to say for the measurement.

The measured variable does not have to correspond directly to the residual curvature; it is sufficient for the measured variable to constitute a value representing the residual curvature. The measurement may be tactile (that is to say contact-based) or contactless, for example, using optical and/or electromagnetic apparatuses. It is important that the measuring technology used to set a straightener allows statements about the residual curvature or the straightening quality in that straightening plane in which the respective straightener operates.

The measuring device comprises an optical measuring system that produces two mutually perpendicular laser light curtains located in the measuring plane by way of laser radiation and performs detection by way of opposing light-sensitive sensors, as a result of which the position of the straightening good is able to be ascertained with high precision in two directions by way of shadow projection. The contactless measurement does not affect the shape of the rod to be measured.

It is possible to determine that residual curvature that is present in the curvature plane that is influenced by the respective roller straightener (plane perpendicular to the axes of rotation of the straightening rollers) simply from the distance, present in the measuring plane, between the measured position of the wire section and a reference position located in the measuring plane that would be present if the straightening good had the target residual curvature. This reference position is preferably not located on a straight line connecting the two fixation points, but rather takes into account the deflection, present due to gravity, of a straightening good resting on the fixation points. To determine the position of this reference point, it is likewise possible to use the parameters of the straightening good that were used for the sensitivity analysis, if necessary modified by the fact that the straightening good is repeatedly transformed in the straightening process and thereby, where applicable, modified with regard to its elastic properties.

This disclosure also relates to a method of setting up a straightening system for straightening passing straightening good in the form of wires or tubes, in which a measuring apparatus and a measuring method are used.

Further advantages will become apparent from the description of examples which are explained below on the basis of the figures.

Examples of measuring units and measuring methods of measuring residual curvatures on straightened straightening good in the form of wires or tubes are explained below. The straightening good has passed through a straightening system having two series-connected roller straighteners with straightening planes oriented perpendicular to one another. The straightening good, in the example, a wire, may be processed further in a forming machine to produce straight or bent shaped parts from the straightening good. The measuring units and measuring methods may be used, for example, when setting up a straightening system.

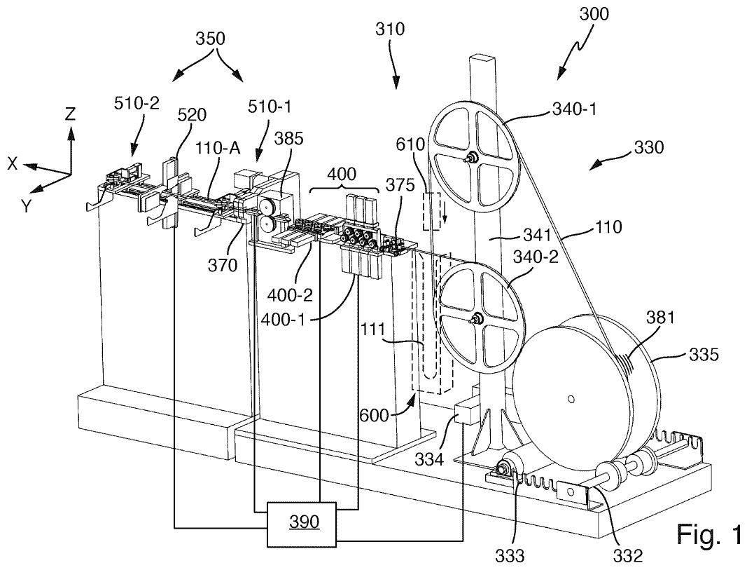

FIG. 1 shows components of a wire processing installation that is designed and set up to process elongate workpieces 110 in the form of metal wires, which are available as a workpiece supply in the form of what is known as a coil, that is to say a wire bundle wound in the manner of a coil. From the workpiece material, which is originally present in a large length on the workpiece supply, smaller or larger numbers of identical or non-identical shaped parts are produced by forming in a computer-numerically controlled production process. The shaped parts may be, for example, helical springs, in particular compression springs or tension springs, or else bent parts having a different geometry. Shaped parts may generally be bent in two dimensions or three dimensions, and may also be present in the form of straight rods (for example, in straightening machines or rod-making machines). The Cartesian x-y-z machine coordinate system is used to better describe directions and positional relationships.

In the state configured ready for operation, the wire processing installation comprises a forming machine (not illustrated), which may be designed, for example, as a spring coiling machine in the production of helical springs.

Furthermore, provision is made for a device 300 for feeding the elongate wire-shaped workpiece material to the forming machine. The device 300 is also referred to for short as feeding device 300. The feeding device is a forming machine that produces a straightened wire from wire that is curved to a greater or lesser extent from the wound wire supply by forming. FIG. 1 shows a few components of the feeding device 300 at a setup station 350.

One object of the feeding device 300 is to feed the wire in a straightened-out form (residual curvature near zero in the tolerance range) to a downstream forming machine or the pull-in apparatus thereof at any time as precisely as possible at the speed required at that time. The feeding device 300 has its own control unit 390, which communicates with the control unit of the forming machine. The functionalities of the two control units may be integrated in a single control unit.

After the setup at the setup station is complete, the feeding device is moved to its working position on the forming machine to be supplied. For this purpose, the illustrated components are mounted on a moveable platform, which may, for example, be moved linearly on guide rails or mounted to be able to rotate about a vertical axis of rotation or be able to be moved without guidance (for example, on rollers or wheels).

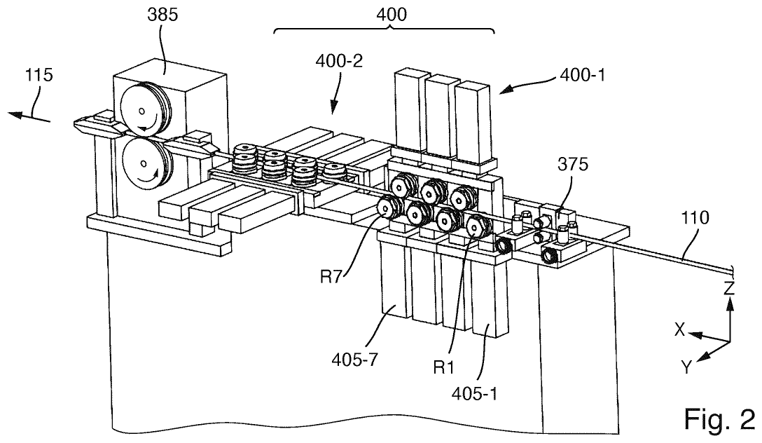

The feeding device comprises a feeding unit 310, which has a receiving apparatus 330 for receiving a workpiece supply 381 in the form of a coil and a downstream straightening system 400 for straightening the workpiece before entry into the forming machine. The straightening system 400 is shown in detail in FIG. 2.

FIG. 1 shows the feeding unit 310 at a setup station 350, which enables a machine operator, on a straightening system 400 located at the setup station 350, to perform all tasks required to set the straightening system to the workpiece material being used such that the feeding unit, during productive operation, that is to say when the feeding unit is in its working position on a forming machine, is able to deliver straightened workpiece material with a high straightening quality, in particular material without residual curvature or with residual curvature only within the tolerance range.

The workpiece supply (coil) is held on a replaceable reel 335, which is received by a receiving device 330 and is mounted to be able to rotate about a horizontal axis of rotation in the received state. The bearing is not in the region of the axis of rotation of the reel; instead, two axially parallel bearing rollers 332, 333 having horizontal axes of rotation are installed in the bottom region. These bearing rollers are part of the receiving device 330. The reel is placed on the two bearing rollers such that the circumference of the disk-shaped side elements of the reel rests on the two bearing rollers, and the position of the axis of rotation in space is defined. In the example, this is an active reel with its own drive. The drive 334 engages with the front bearing roller 333 and is able to drive it with control by the control unit 390.

The unwound wire is guided via a deflection apparatus 340, which has an upper deflection roller 340-1 and a lower deflection roller 340-2, which are mounted to be able to rotate in an axially parallel manner on a vertical carrier 341. The upper deflection roller is designed as a vertically moveable dancer roller having a spring return mechanism. The drive motor for the bearing/drive roller is controlled by querying the position of this roller. The lower deflection roller is wrapped around over approximately three quarters of its circumference such that the exit, that is to say the top of the lower deflection roller 340, is level with the entrance-side passage opening of the straightening system 400.

The wire is thus guided by the lower deflection roller essentially horizontally to the straightening system 400. Between the deflection apparatus and the straightening system, there is a wire guide apparatus 375 the output of which is aligned with the input of the downstream straightening system 400. A wire end detection apparatus may be integrated into the wire guide apparatus.

An alternative design is illustrated/indicated in FIG. 1 with dashed lines. The lower deflection roller is dispensed with here. The design comprises a buffer store 600 in the form of a relatively flat storage box that is open on one side (here at the top) and an upstream auxiliary pull-in apparatus 610, which may be arranged, for example, downstream of the upper deflection roller 340-1. The auxiliary pull-in apparatus may be driven by way of an auxiliary drive and is configured to convey the workpiece, that is to say the wire in the example, to the downstream buffer store 600 at a predefinable conveying speed. The buffer store has an entrance and an exit for the workpiece. The buffer store is designed such that the workpiece is able to form a workpiece loop 111 of variable length between the entrance and exit in the buffer store. This makes it possible to compensate for speed differences between the regions upstream and downstream of the buffer store. Provision is preferably made for a sensor system for detecting the fill level of the buffer store and for generating sensor signals representing the fill level. The controller may then be configured such that the conveying speed of the auxiliary pull-in apparatus is controllable or controlled on the basis of sensor signals from the sensor system. If required, a buffer store may also be installed horizontally such that the workpiece loop is formed in a plane that is oriented substantially horizontally. For further details and variants, reference should be made to WO 2020/224977 A1, the disclosure content of which regarding the structure of the feeding apparatus is incorporated by reference into the content of this description.

The straightening system 400 comprises two directly series-connected roller straighteners 400-1, 400-2, able to be set independently of one another, which each have a number of axially parallel straightening rollers. Seven straightening rollers are provided, and other numbers, for example, five to nine, are also possible. The axes of rotation of the straightening rollers of the series-connected straighteners are oriented orthogonal to one another.

In a roller straightener, straightening rollers produce alternating bends through off-center setting in relation to a neutral axis of the straightening good, which deform the straightening good into the plastic domain and thereby straighten it. In contrast to a roller straightening machine, the straightening rollers are passive or not rotationally driven, and so there are no drives for the rotation of the straightening rollers. The wire is pulled through the roller straighteners. For this purpose, provision is made for a pull-in apparatus 385 that is arranged downstream of the straightening system 400 in the material flow direction and is used, inter alia, to pull the wire material through the two roller straighteners 400-1, 400-2 of the straightening system 300 in the direction of the following components.

The components of the straightening system 400 are supported by a frame part in which the control unit 390 of the feeding unit 310 may also be accommodated. The frame part also supports the pull-in apparatus 385. The pull-in apparatus 385 is designed in the example as a roller feed and may also be configured, in other examples, as a belt pull-in apparatus or a gripper feed. In the material flow direction downstream of the pull-in apparatus 385, provision may be made for an optional, possibly manually operable clamping apparatus by way of which the axial position of the wire carried through may be fixed if necessary.

Further details are explained with reference to the example of the first roller straightener 400-1 active in the vertical plane (x-z plane), which is illustrated in magnified form in FIG. 2.

The first roller straightener 400-1 has seven passive straightening rollers R1, . . . . R7 having mutually parallel horizontal axes of rotation that are arranged alternately on opposing sides of a throughfeed path (parallel to the x-axis) in a throughfeed direction 115. During operation of the straightening system, the straightening rollers define, with their circumferential sections in contact with the straightening good 110, the effective straightening geometry of the roller straightener. The first roller straightener 400-1 changes the curvature essentially only in a vertical plane (x-z plane), the straightening plane. The second roller straightener 400-2, which is responsible for straightening in a horizontal plane, is designed in the same way; the straightening roller axes of rotation run vertically.

In the example, all seven straightening rollers are designed as automatically adjustable straightening rollers and are able to be adjusted bidirectionally, independently of one another, in an adjustment direction oriented perpendicular to the throughfeed direction (parallel to the z-axis) automatically by way of servo motor drives 405-1, . . . , 405-7 in response to control signals from the control unit 390.

There are also variants in which all straightening rollers are manually adjustable. For this purpose, provision may be made, for example, for setting screws and position indicators. There are also examples in which one fraction of the straightening rollers (for example, two, three or four) may be adjusted automatically and another fraction (for example, three, four or five) may be adjusted manually.

Due to the large number of degrees of freedom in terms of setting, a machine operator with a great deal of experience is required for the correct setting of a roller straightener. The setting operation or setup takes a considerable amount of time.

The setup station 350 or setting station 350 comprises a cutting apparatus 370 by way of which, in the course of the setting work on the straightening system, rod-shaped wire sections 110-A are severed from the fed-in wire for test purposes and thus provided for a straightness test. In the example, provision is made for an automated cutting apparatus 370; alternatively, provision may be made for a manually operable cutting apparatus. Furthermore, the setup station 350 has a measuring device 500.

The wire sections or wire rods 110-A severed by way of the cutting apparatus are tested for straightness or residual curvatures using the downstream measuring device 500. In the process, anti-twist apparatuses ensure that the rotational position of the material rod provided for the measurement remains unchanged about its longitudinal axis such that the wire is measured in that rotational position in which it passed through the straightening system.

The measuring device 500 and the associated cutting apparatus 370 are components of a measuring unit 350, which, possibly together with further components, forms an autonomous unit that may serve as a setup station 350. Therefore, the same reference numeral 350 is used for the setup station and the measuring unit.

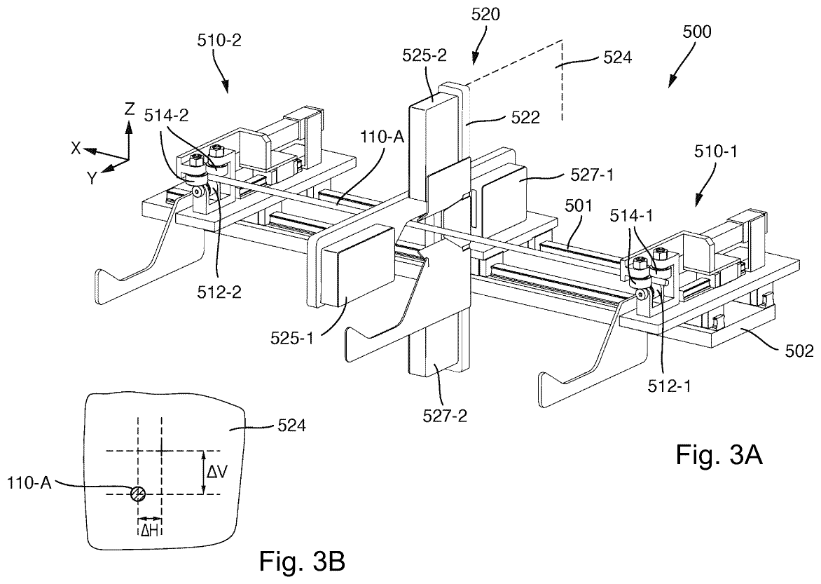

FIG. 3A shows a magnified detailed illustration of components of the measuring device 500. The measuring device 500 comprises, on the side facing the cutting apparatus 370, a first clamping device 510-1 and a second clamping device 510-2 downstream at a distance therefrom. The clamping devices are mounted on carriages that run on two guide rails 501 that are attached to the top of a horizontally oriented baseplate 502. The axial distance between the clamping devices as measured parallel to the throughfeed direction may thus be adjusted continuously. Each of the clamping devices has a support roller 512-1, 512-2 mounted with a horizontal axis of rotation and two pneumatically adjustable transverse positioning rollers 514-1, 514-2. This means that an inserted wire rod is able to be fixed at a fixation point that is precisely defined both in the vertical direction and in the horizontal direction. The rollers make contact with the wire without introducing additional forces or torques such that the wire rod rests at defined fixing positions at the front and rear and is exposed only to gravity in the region between. The rod is not able to rotate about its axis if it is clamped gently between the horizontally moveable rollers 514-1, 514-2.

Components of a measuring system 520 are mounted in the region between the clamping devices 510-1, 510-2. These are supported by a cross-shaped carrier 522 that is mounted on a carriage that is able to be moved on the guide rails 501 that also guide the clamping devices. The measuring system 520 is an optical measuring system that is able to ascertain the position of the set-down wire in a measuring plane 524 oriented perpendicular to the x-direction with high precision. Mounted above the straight connecting line between the fixation points is a second laser unit 525-2 that produces a laser light curtain located in the measuring plane 524, this falling into the detection area of a photosensitive sensor 527-2 on the opposite side such that the position of the wire is able to be detected accurately in the transverse direction (horizontal direction) in the shadow that is cast. The position in the vertical direction is detected using a first laser unit 525-1 and the opposite sensor 527-1. The measurement is preferably carried out in the middle between the two fixing elements by way of the two lasers in the horizontal and vertical direction.

The magnified detail in FIG. 3B illustrates a typical measurement situation. The plus symbol represents the intersection of the connecting lines between the fixation points and the measuring plane 524. The hatched circle represents the position of the wire section 110-A in the middle between the clamping devices. A residual curvature of the wire rod in the respective straightening planes may be calculated from the distance values AH in the horizontal direction and AV in the vertical direction. The results are thus straightening plane-specific and are evaluated accordingly to provide separately determined instructions for improving the straightening geometry, where applicable, for each of the two roller straighteners.

The evaluation takes into account the fact that the wire rod is subjected to a certain deflection due to gravity alone, the extent of which depends on material characteristics and the distance between the fixation points. This contribution is removed from the evaluation. The result of the measurement is a quantitative value for the residual curvature, which may have contributions both in the horizontal and in the vertical direction. Based on these measured values, the straightening geometry of the roller straighteners should then be adjusted such that the residual curvature disappears in a following wire piece.

We found a potential problem when processing round material. It may be that a round rod that still has a considerable bulge in the horizontal plane after straightening automatically rolls into a stable rotational position when inserted into the measuring device in which the bulge sags downwards. This would simulate a bulge in the vertical direction that does not actually exist, which would lead to erroneous measurement results and, as a result, to incorrect adjustments and/or incorrect adjustments on the wrong straightener.

To ensure that the measurement results are able to be assigned accurately to the different straightening planes or roller straighteners (horizontally and vertically), special measures are taken where necessary to ensure that the wire rod provided for the measurement is not able to rotate about its longitudinal axis between the severing from the rest of the straightening good and the measurement. The measuring system is for this purpose configured for a straightening plane-specific or straightening plane-selective measurement.

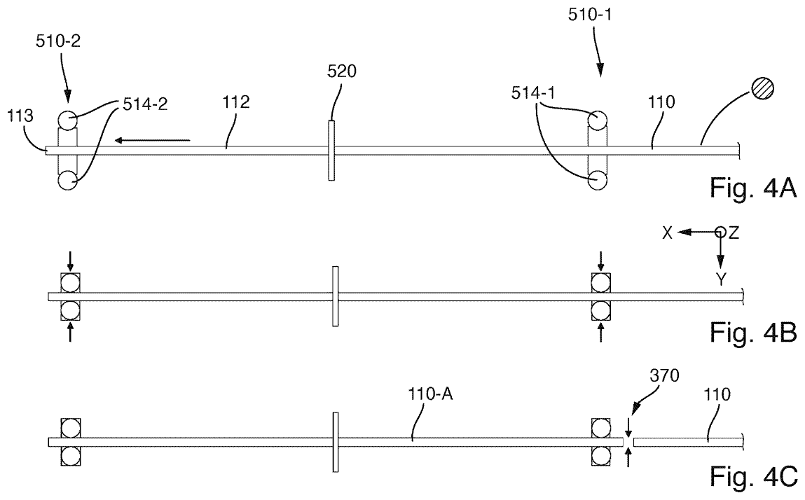

One method variant, illustrated schematically in FIGS. 4A to 4C, is suitable for a large number of materials of different cross-sectional shape, in particular including for round material. The method variant is such that, first of all, the front end section 112, adjoining the front end face 113, of the straightened wire is conveyed to a measuring position in the measuring device 500 by way of a controlled advancement (by the upstream pull-in apparatus 385) (FIG. 4A), and then contacted on diametrically opposing sides by way of the rollers 514-1 and 514-2, able to be moved in the transverse direction, of the clamping devices 510-1, 510-2, and thereby clamped horizontally and thus prevented from rotating (FIG. 4B), and that the rod to be measured is only then severed from the rest of the straightening good (FIG. 4C). The measurement by way of the optical measuring system 520 then begins.

The horizontally moveable rollers 514-1 and 514-2 of the clamping devices act as an anti-twist apparatus, make contact with the wire material at two contact points that are diametrically opposite in the horizontal direction with relatively low pressure, which is dimensioned such that the static friction is sufficient to prevent self-rotation of the rod about the longitudinal axis, but at the same time that the wire rod is able to relax such that it is otherwise free from forces aside from gravity, and thus exhibits those residual curvatures that are to be measured.

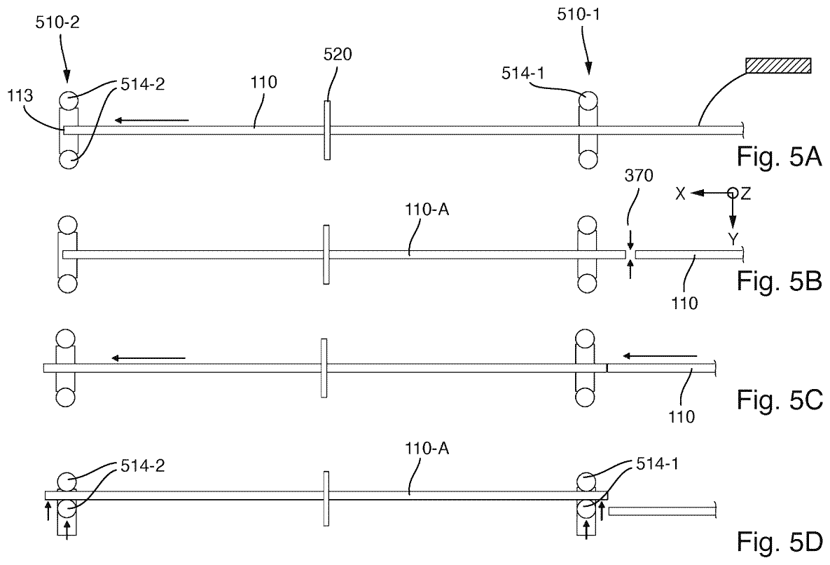

FIGS. 5A to 5D illustrate another method variant for checking the straightness of rods using the measuring device. First of all, the wire with a flat rectangular cross section (see detail) is advanced to a cutting position by the wire advancement by way of the pull-in apparatus 385. This is characterized, inter alia, in that the front end 113 of the rod has already reached the support roller of the rear or second clamping device 510-2 and is resting there. During this threading operation, the transverse positioning rollers are in their retracted positions. The cut is then made by way of the cutting apparatus 370 (FIG. 5B). In the next method step (FIG. 5C), the severed wire piece is pushed further forward into its measuring position, in which the wire rod is centered in relation to the measuring plane located in the middle and protrudes beyond the support roller on both sides by parts of equal length. No special setup is required for this short wire advancement. On the contrary, the following wire piece is brought toward the rear end of the wire rod to be measured by way of the pull-in apparatus 385 such that it is able to effect the horizontal advancement in the manner of a plunger. In a next phase (FIG. 5D), the transverse positioning rollers are moved in the direction of the intended fixing positions by way of their pneumatic cylinders. In addition, the wire piece is pressed onto the rear stop to ensure a defined plane. The wire rod is thus fixed for the measurement. It is easy to see that the connecting line between the front and rear fixing positions does not have to be coaxial with respect to the advancement axis of the following wire.

Advantageous measuring apparatuses and procedures have been explained by way of example with reference to the example of the setup of a forming machine in the form of a feeding device, which, when used as intended, uses the integrated straightening system to form straightened wire material from wire material fed from a coil and arriving with a varying input curvature, which wire material is fed to a downstream forming machine as a “continuous material”.

The straightening system may have exactly two roller straighteners, which preferably produce mutually perpendicular straightening planes. A straightening system may also have three or four or more roller straighteners. By way of example, a straightening system may have four straighteners each offset by 45° which may, for example, be a favorable variant for straightening round wire.

The forming machine in which the straightening system is integrated may also be a straightening and cutting machine that is designed to straighten wires or other semi-finished materials having different cross-sectional sizes and shapes and able to be machined by straightening, and then cut the straightened straightening good to a desired length. The machine then additionally has a length measuring apparatus and a cutting device, which may preferably be actuated automatically based on signals from the length measuring apparatus. The measuring unit may then measure the severed straightened rods. The measuring unit does not require its own cutting apparatus for this. It may also be a rod-making machine that, in addition to the straightening system, a cutting apparatus and a length measuring apparatus, also has a stripping apparatus to remove sections of the insulation from a metallic starting material coated with an insulating layer.

A straightening system may also be integrated into a forming machine that is able to produce smaller or larger series of shaped parts with partly complex geometry from the straightened straightening good in an automatic production process using appropriate forming tools. The forming tools required for forming are then connected downstream of the straightening system. The forming machine may be, for example, a bending machine for producing bent parts from wire material, strip material or tube material, or a spring-making machine or a wire-pin machine for mass production of screws, nails, rivets or the like.

Our units and methods may be used for different types of straightening good, in particular for straightening metallic wire material or tube material. The cross-sectional shape of the straightening good may be different, for example, a circular cross section in round material, a profiled and/or polygonal cross section in profile material, in particular a rectangular cross section in square material. Flat material such as, for example, flat metallic belts with a large aspect ratio between width and height, may also be straightened. The cross-sectional size may also vary. The metallic material may be uncoated or have a coating, for example, an electrically non-conductive insulating layer made of plastic.

The straightness test or measurement does not have to be performed as described in the example. The straightness test may also be carried out automatically using at least one camera. By way of example, in flat material, the straightness may also be checked while it is passing through using two cameras offset by 90°. In particular in round wires, it is possible to use a camera rotating around the wire or a laser scanner.

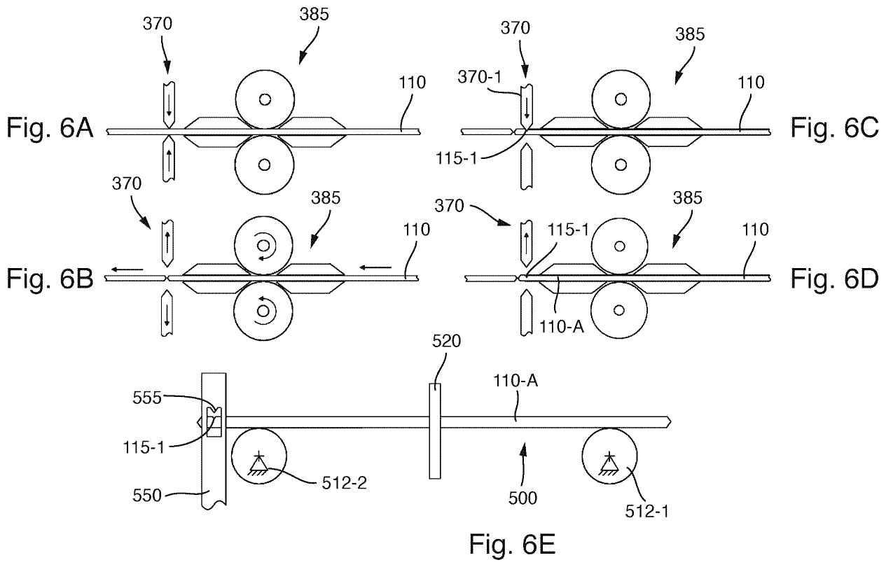

With reference to FIGS. 6A to 9, a description is now given, by way of example, of various examples each having, on the feeding unit, apparatuses for generating a rotational position marking and, on the measuring unit, a rotational position adjustment auxiliary apparatus. A rotational position marking may thus be produced by the feeding unit on a rod-shaped section, making it possible to unambiguously identify the rotational position in which the rod-shaped section was straightened. Provision is made, on the measuring unit, for a corresponding rotational position adjustment auxiliary apparatus, which makes it possible, in functional interaction with the rotational position marking on the rod-shaped section, to receive same in a defined rotational position in the measuring unit such that the measured values determined by the measuring unit are able to be put into a clear relationship with the rotational position in which the straightening good passed through the straightening system. The rod-shaped section may be transported between the feeding unit and the measuring unit manually, semi-automatically or automatically, without it being necessary to maintain a specific rotational position or orientation of the rod-shaped section throughout the transport. By way of example, an operator may pick up a marked rod-shaped section after it has been severed from the wire, insert it into the measuring unit, and place the wire into the measuring unit with the correct rotational position using the rotational position marking and the corresponding rotational position adjustment auxiliary device.

FIGS. 6A to 6D show the region of the pull-in device 385 and the downstream cutting apparatus 370 of one example in various phases of the production of a rotational position marking on a rod-shaped section 110-A of the straightening good 110. The straightening good is a round wire. FIG. 6A shows the cutting tools before penetration of the wire during a cutting operation. FIG. 6B shows the retraction movement of the cutting tools after the wire has been cut through. The cut severed a rod-shaped section, and the next one is to be produced. After a finished rod-shaped section has been severed, the wire is advanced a short amount, for example, a few centimeters, by way of the pull-in apparatus 385. Then, using the upper cutting tool 370-1, a V-shaped notch 115-1 is impressed or applied to the top of the wire a short distance from the front end in a notching operation (FIG. 6C). After the cutting tool 370-1 used for the notching has been retracted, the rotational position marking 115-1 formed by the notch 115-1 may be seen at the top of the wire. The wire (the straightening good) is then advanced until the next separation point reaches the region of the cutting apparatus 370. The rod-shaped section 110-A marked with the notch 115-1 is then severed.

Since the wire is still attached to the fed-in wire when the notch 115-1 is introduced (FIG. 6C), the bottom of the V-shaped notch runs parallel to the horizontal direction and the notch is located at the top, from which it is possible to recognize the vertical direction. The notch 115-1 may thus be used to clearly identify the rotational position that the wire was in during straightening.

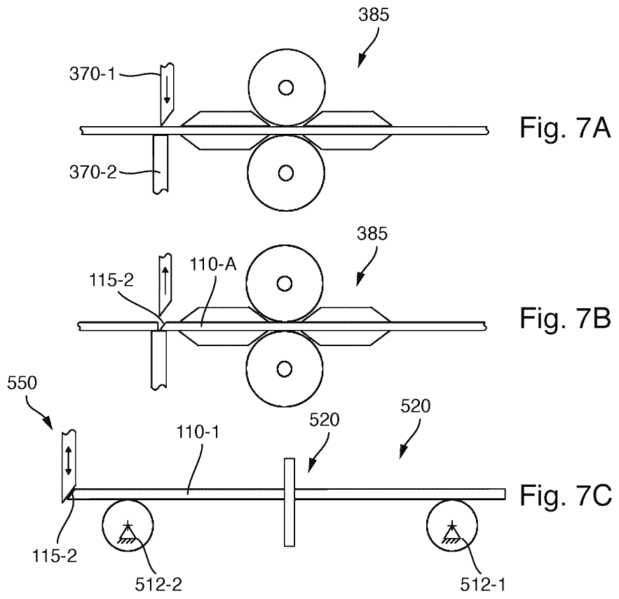

FIG. 6E shows the insertion of the rod-shaped section 110-A into the measuring device 500 with the correct orientation or rotational position, which may be identified using the notch 115-1 or the rotational position marking. The rod-shaped section 110-A is placed on the support rollers 512-1, 512-2 such that the rod end with the marking 115-1 is beyond the rear support roller 512-2. There, the measuring unit has a rotational position adjustment auxiliary apparatus 550 having a downwardly oriented wedge 555 the V-shaped design of which corresponds to that of the cutting edge of the cutting tool 370-1. The wire may thus be oriented exactly as it passed through the straightening unit by way of the marking on the wire and the corresponding recess on the measuring station. This means that the curvature components represented by the measurement data may be assigned unambiguously to the different straightening planes of the roller straighteners (straightening plane-specific measurement).

Whereas, in the variant of FIGS. 6A to 6E, provision is made for a notching operation separate from the cutting operation after the wire has been advanced to produce the notch 115-1 serving as rotational position marking, in the variant of FIGS. 7A to 7C, the rotational position marking is produced during the cutting operation. The cutting apparatus has an upper cutting tool 370-1 having a one-sided bevel, which interacts with a non-cutting lower cutting tool as a counter-holder. The cutting movement takes place from only one side such that an oblique chamfer 115-2 intended as a rotational position marking is created at the end of the wire, the orientation of which allows unambiguous identification of the rotational position of the wire during the cutting.

In the corresponding measuring unit, beyond the second support roller, there is a rotational position adjustment auxiliary apparatus 550 that comprises a vertically moveable stop that, on its lower end, has an inclined surface corresponding to the inclined surface on the cutting wedge of the cutting tool. The rod-shaped section is inserted such that the chamfer 115-2 on the end face of the rod-shaped section 110-A bears flat against this stop. The correct orientation is thus defined by the mechanical contact with this bevel. The stop may then be moved out of engagement with the rod-shaped section so that the measurement is not affected by the contact with the stop.

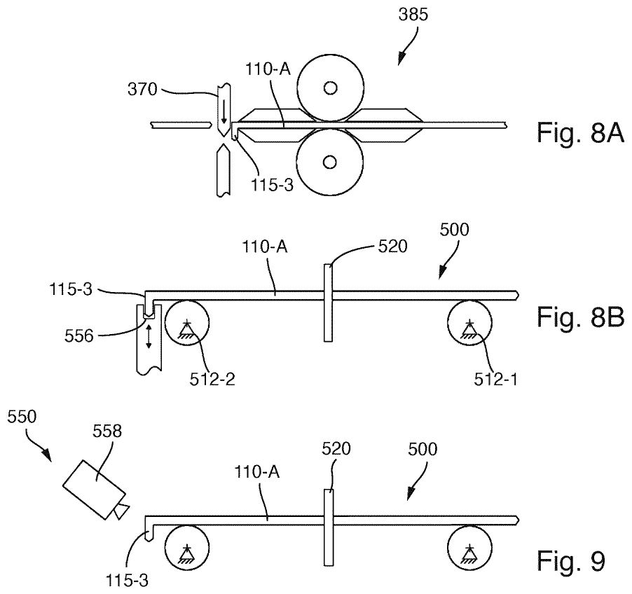

In the example of FIGS. 8A and 8B, following the severing of a previous rod-shaped section at the front end of the next rod-shaped section 110-A, a short piece of the wire is bent by around 90° such that a short end piece 115-3 of the rod-shaped section protrudes radially parallel to the vertical plane. This bend or the radially protruding end piece 115-3 serves as a rotational position marking and was introduced following the severing of the previous rod-shaped section, in the example, by the cutting tool 370-1 itself. Alternatively, a separate bending tool is possible.

Provision is made on the measuring device 500 (FIG. 8B) for a rotational position adjustment auxiliary apparatus 550 having a marking counter-element corresponding to the bend 115-3, which counter-element has a recess 556 into which the bend fits. The rod-shaped section 110-A is inserted into the measuring device such that the bent end piece fits into the recess. For the measurement, the marking counter-element may be moved downward so that the recess comes out of engagement with the rod-shaped section and this is free from forces for the measurement.

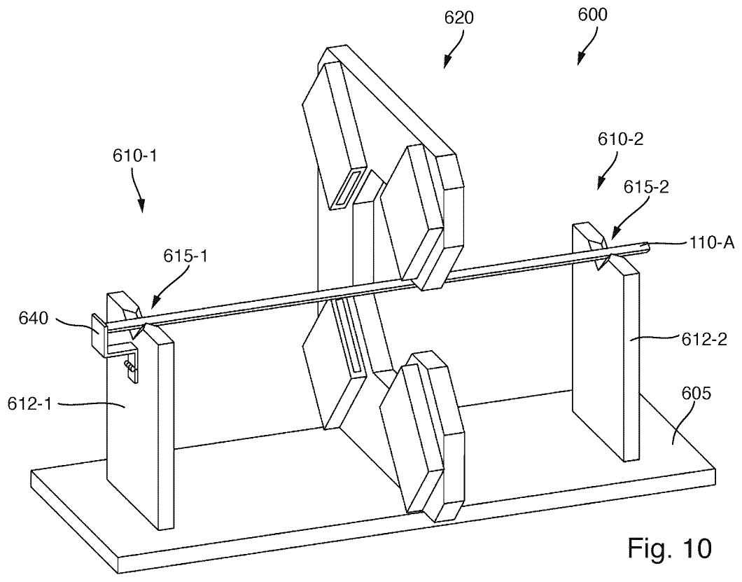

FIG. 9 schematically illustrates one alternative in which the rotational position adjustment auxiliary apparatus 550 of the measuring device comprises a camera 558 by way of which the front end of an inserted rod-shaped section 110-A is able to be detected. The rotational position marking (for example, a bend 115-3) is thus identified contactlessly using an optical measuring system. Alternatively, for example, a line laser may also be used as optical measuring system. The measured values delivered by the optical measuring system are then processed to ascertain the rotational position of the rod-shaped section 110-A during the measurement and thus to establish a relationship with the orientation of the straightening planes in the straightening unit.

Schematic FIG. 10 shows a further example of a measuring device 600, which is designed to measure a rod 110-A of finite length after straightening and severing from the tracked straightening good with regard to possible curvatures. The measuring device 600, which is of relatively simple and robust design, may be placed at a suitable location in a production hall and may be used by various machine operators to measure straightened rods with regard to possible curvatures from time to time and in the process to perform a straightening plane-specific measurement. The measuring device 600 may be mounted, for example, on a trolley to be able to be used at different locations, but stationary mounting is just as possible.

The measuring device 600 has a relatively heavy, torsionally rigid baseplate 605 that may be mounted, for example, on the top of a trolley and carries all other components of the measuring device. The measuring device 600 has a first fixation device 610-1 and a second fixation device 610-2 at a distance therefrom in the x-direction. These are designed such that a rod to be measured is able to be received in a precisely defined spatial position without forces. The distance in the x-direction is dimensioned such that it is slightly smaller than the shortest rods to be measured.

Each fixation device has a bearing block 612-1, 612-2 in the form of a plate positioned vertically in the y-z plane. At the top of each bearing block is formed a substantially V-shaped rod receptacle 615-1, 615-2 that widens upwardly. The flanks of the rod receptacles are each arranged obliquely at an angle of 45° to the x-z plane or to the vertical and are each roof-shaped such that each rod receptacle at the ridge of the roof shape forms only a point-shaped or linear contact surface with the inserted rod.

In the example, a rod 110-A made of flat material having a rectangular cross section is measured. The broad side is in linear contact with one of the flanks, and the narrow side abuts the other flank with linear contact near the bottom of the V-shape. This predefines and fixes the position of the rod material in the y-z plane both in the vertical direction (z-direction) and in the horizontal direction (y-direction), without forces (aside from gravity) acting on the set-down rod.

It is just as possible to measure round material; in this example, this results in respective point-shaped contact regions on the inwardly protruding edges of the flanks of the rod receptacle.

A hinged stop 640 is provided on the outside of the bearing block of the first fixing apparatus 610-1 and makes it easy to insert the rod such that the rod center is located exactly in the middle between the support points of the fixing device.

In measuring flat material, a precisely known relationship between the rotational position during straightening and cutting, on the one hand, and the rotational position during measurement, on the other hand, is generally obtained automatically in the placement process since these are twisted by 45° in relation to one another. In round material, the relationship may be ensured, for example, using a rotational position marking (for example, color marking, plugged or clamped marking element or the like) and a corresponding rotational position detection apparatus on the measuring device.

It may be that a straightened rod, for example, after a first straightening operation, still has a relatively large curvature and/or is somewhat twisted on itself, meaning that it is not ensured that the rod bears on both fixation points (front and rear or on the first and the second fixing device) with a defined position. Nevertheless, to ensure a reliable measurement, in some examples, provision is made, on one of the two fixing devices, for an additional clamping element that is designed to engage on the portion of the rod located in the rod receptacle and to press the section against a flank of the rod receptacle with low force. By virtue of this small force acting only on one end section of the rod, it is possible to ensure a defined rotational position of the rod on this rod receptacle, without a force that changes the curvature state to be measured being exerted on the rod as a whole.

The actual measurement runs largely in the same way as the measurement operations already described in the other examples. The components of a measuring system 620 are mounted centrally between the fixing devices 620-1, 610-2. The measuring system works optically and is able to ascertain the position of the set-down wire or rod with high accuracy in a y-z plane (measuring plane) located centrally between the fixing devices. The electro-optical components of the measuring system (two laser units and corresponding sensors for shadow casting measurements) are attached to a C-shaped carrier that is open at the visible front and thus makes it easy to insert a rod manually. In contrast to the variant of FIG. 3A, the measuring directions that are oriented orthogonally to one another are not horizontal and vertical, but rather inclined by 45° to the horizontal direction (y-direction). This corresponds to the inclined position of the rod that results from the V-shaped receptacles at the fixation points. Due to the inclined orientation, for example, when measuring flat material (as shown in the example), the curvature components on the broad sides and the narrow sides need to be recorded and evaluated particularly precisely. Otherwise, reference is made to the previous example with regard to the operation.

1. A measuring unit that measures residual curvatures on straightened straightening good in the form of wires or tubes, which straightening good has passed through a straightening system having two series-connected settable roller straighteners with differently oriented straightening planes, comprising:
a measuring device that receives a respective rod-shaped section, which has been severed from the straightening good, of the straightening good that has passed through the straightening system in a measuring position and that determines measurement data that represent a residual curvature of the straightened straightening good;
wherein
the measuring unit is configured for a straightening plane-specific measurement that allows an unambiguous assignment of the curvature components represented by the measurement data to the different straightening planes of the roller straighteners.

2. The measuring unit as claimed in claim 1, further comprising:
fixing apparatuses that fix the rod-shaped section at a first fixation point and at a second fixation point located at a distance from the first fixation point such that, for each of the fixation points, only a vertical position and a horizontal position of the rod-shaped straightening good is predefined such that a section of the rod-shaped straightening good that is located between the fixation points is free from forces aside from gravity;
measuring apparatuses for measuring that measure a position of the straightening good in a measuring plane located between the first and the second fixation point; and
apparatuses that determine the residual curvature using position data for the position of the straightening good at the first fixation point, at the second fixation point and in the measuring plane.

3. The measuring unit as claimed in claim 1, wherein the measuring unit has a cutting apparatus that severs rod-shaped sections of predefinable length from the straightening good that has passed through the straightening system, and the cutting apparatus is mounted, together with the measuring device, at or on a common frame.

4. The measuring unit as claimed in claim 1, wherein the measuring unit is configured such that the straightening good is able to be measured in that rotational position in which it passed through the straightening system.

5. The measuring unit as claimed in claim 1, further comprising anti-twist apparatuses that are configured such that a rotational position of a severed rod-shaped section provided for the measurement remains unchanged about its longitudinal axis between the straightening and the measurement such that the straightening good is able to be measured in that rotational position in which it passed through the straightening system.

6. The measuring unit as claimed in claim 1, further comprising a control unit that is configured in an operating mode such that the cutting apparatus and the measuring device are controlled in a coordinated manner such that a front end section of the straightened straightening good is conveyed to a measuring position in the measuring device by way of a controlled advancement, the straightening good is then secured against twisting by way of anti-twist apparatuses of the measuring unit or is clamped in the horizontal direction, and the cutting apparatus is then actuated to sever the rod-shaped section to be measured from the rest of the straightening good.

7. The measuring unit as claimed in claim 1, wherein the measuring unit has a rotational position adjustment auxiliary apparatus that is configured, in functional interaction with a rotational position marking on the rod-shaped section that is suitable for identifying the rotational position of the rod-shaped section, to ensure that the rod-shaped section is able to be received in the measuring unit such that the rod-shaped section is able to be measured in a defined rotational position that has a known relationship with the rotational position in which the straightening good passed through the straightening system, the rotational position adjustment auxiliary apparatus has at least one rotational position detection apparatus that is configured to detect the rotational position marking on the rod-shaped section, and the rotational position detection apparatus is selected from the following group:
a camera for optically detecting the rotational position marking;
a mechanical marking counter-element for making mechanical contact with the rotational position marking, wherein the marking counter-element has a section having a counter-structure complementary to the rotational position marking such that the desired rotational position of the rod-shaped section is able to be set by the contacting.

8. The measuring unit as claimed in claim 1, wherein the measuring device, on an input side, has a first clamping device and a second clamping device at a distance therefrom in the longitudinal direction, components of a measuring system are arranged in a region between the clamping devices, which measuring system defines a measuring plane oriented transverse or perpendicular to the longitudinal direction and is designed to ascertain the position of the set-down rod-shaped section in the measuring plane, and each of the clamping devices has a support roller mounted with a horizontal axis of rotation and two transverse positioning elements able to be adjusted by way of a drive or transverse positioning rollers or transverse positioning blocks such that an inserted rod-shaped section is able to be fixed at a fixation point defined in the vertical direction and in the horizontal direction.

9. The measuring unit as claimed in claim 8, wherein a distance, measured parallel to the longitudinal direction, between the clamping devices is continuously adjustable, and the clamping devices are mounted on carriages that run on guide rails that are attached to the top of a horizontally oriented baseplate of the measuring system, and/or components of the measuring device are attached to a carrier that is mounted on a carriage that is able to be moved on the guide rails that also guide the clamping devices.

10. The measuring unit as claimed in claim 1, wherein the measuring system is an optical measuring system that ascertains the position of the rod-shaped section in a measuring plane located between the clamping devices, the measuring system has a first laser unit and a second laser unit that produce a respective laser light curtain running in the measuring plane in measuring directions oriented transverse or perpendicular to one another, and a sensor unit having photosensitive sensors that detect a shadow cast by that part of the rod-shaped section entering through the measuring plane is arranged opposite a laser unit.

11. A measuring method of measuring residual curvatures on straightened straightening good in the form of wires or tubes, which straightening good has passed through a straightening system having two series-connected roller straighteners with differently oriented straightening planes, wherein
a rod-shaped section of predefinable length is severed from the straightened straightening good that has passed through the straightening system by way of a cutting apparatus, and
the rod-shaped section is measured by way of a measuring apparatus that comprises a measuring device that receives a respective rod-shaped section severed from the straightening good in a measuring position and apparatuses that determine measurement data that represent a residual curvature of the straightened straightening good,
comprising a straightening plane-specific measurement, in which curvature components determined on the basis of the measurement data are assigned to the different straightening planes of the roller straighteners.

12. The measuring method as claimed in claim 11, wherein a rotational position of the straightening good remains unchanged about its longitudinal axis between the straightening and the measurement such that the straightening good is measured in that rotational position in which it passed through the straightening system.

13. The measuring method as claimed in claim 11, wherein, to measure a rod-shaped section of the straightening good, a front end section of the straightened straightening good is first of all conveyed to a measuring position in the measuring device by way of a controlled advancement, the straightening good is then prevented from self-rotation by way of anti-twist protection or by being clamped in the horizontal direction, and the rod-shaped section to be measured is then severed from the rest of the straightening good.

14. The measuring method as claimed in claims 11, comprising:
producing a rotational position marking suitable for identifying the rotational position of the rod-shaped section on the rod-shaped section;
transporting the rod-shaped section provided with the rotational position marking to the measuring unit;
arranging the rod-shaped section provided with the rotational position marking in the measuring position of the measuring unit with a defined rotational position, which has a known relationship with the rotational position in which the straightening good passed through the straightening system,
wherein the defined rotational position is set using a rotational position adjustment auxiliary apparatus of the measuring unit that is configured, in interaction with the rotational position marking on the rod-shaped section, to ensure that the rod-shaped section is arranged in the defined rotational position.

15. The measuring method as claimed in claim 14, wherein producing the rotational position marking (115) comprises one of:
producing a notch or another recessed structure on the circumference of the straightening good;
producing a bent section at the end of the straightening good;
producing a chamfer at the end of the straightening good;
producing a color marking or laser marking;
removing one side of part of an insulating layer;
applying a marking element that has been produced separately and has a matching shape to the rod-shaped section, by plugging, clipping or gluing, and
gluing a self-adhesive sticker to or on a side surface of the rod-shaped section.

16. The measuring method as claimed in claim 11, wherein measuring the straightened straightening good comprises:
fixing the straightened straightening good at a first fixation point and at a second fixation point located at a distance from the first fixation point such that, for each of the fixation points, a vertical position and a horizontal position of the straightening good is predefined and a section of the straightening good that is located between the fixation points is free from forces aside from gravity;
measuring a position of the straightening good in a measuring plane located between the first and the second fixation point; and
determining the residual curvature using position data for the position of the straightening good at the first fixation point, at the second fixation point and in the measuring plane.

17. The measuring method as claimed in claim 11, wherein an optical measuring system is used for the measurement, which optical measuring system produces two mutually perpendicular laser light curtains located in the measuring plane by way of laser radiation and performs detection by way of opposing light-sensitive sensors, as a result of which the position of the straightening good in the measuring plane is able to be ascertained with high precision in two directions by way of shadow projection.

18. A method of setting up a straightening system for straightening passing straightening good in the form of wires or tubes, for use in a forming machine for producing straight or bent shaped parts from the straightening good,
wherein the straightening system has two series-connected settable roller straighteners with differently oriented straightening planes,
a rod-shaped section of predefinable length is severed from the straightened straightening good that has passed through the straightening system by way of a cutting apparatus,
the rod-shaped section is measured by way of a measuring apparatus that comprises a measuring device that receives a respective rod-shaped section severed from the straightening good in a measuring position and apparatuses that determine measurement data that represent a residual curvature of the straightened straightening good, and
the straightening geometry of at least one roller straightener is modified on the basis of the measurement data such that a residual curvature of a subsequently straightened section of the straightening good is improved by changing the straightening geometry with regard to a target residual curvature, and
a measuring apparatus as claimed in claim 1 is used.
